(19) United States
(12) Patent Application Publication
(10) Pub. No.: US 2022/0368737 A1
(43) Pub. Date: Nov. 17, 2022

(54) SYSTEMS AND METHODS FOR HOSTING A VIDEO COMMUNICATIONS PORTAL ON AN INTERNAL DOMAIN

(71) Applicant: CloudEngage, Inc., Spokane, WA (US)

(72) Inventors: Paul WAGNER, Spokane, WA (US); Timothy A. DRAKE, Washougal, WA (US)

(73) Assignee: CloudEngage, Inc., Spokane, WA (US)

(21) Appl. No.: 17/663,316

(22) Filed: May 13, 2022

Related U.S. Application Data
(60) Provisional application No. 63/201,881, filed on May 17, 2021.

(51) Int. Cl. H04L 65/403; H04L 65/402; G06Q 30/06; G06F 21/30; G06Q 30/02

(52) U.S. Cl. CPC H04L 65/403; H04L 65/402; G06Q 30/0633; G06F 21/30; G06Q 30/0271

(57) ABSTRACT

A computer-implemented method for hosting a video communications portal of an external video communications server system on an internal domain is disclosed. The may include receiving a unique path from a user, the unique path including a unique identifier, in response to the receiving, initiating the video communications portal of the external video communications server system, the video communications portal corresponding to the unique identifier, in response to the initiating, displaying the video communications portal within the internal domain, wherein the video communications portal is hosted on the external video communications server system, receiving a user selection from the user to initiate a video communication with one or more visitors, and in response to receiving the user selection, activating the video communication between the user and the one or more visitors.

### TECHNICAL FIELD

Various embodiments of the present disclosure relate generally to hosting a video communications portal of an external video communications server system on an internal domain.

### BACKGROUND

Organizations traditionally depend on video communications platforms that are external to the organization's website for video communications services. Additionally, visitors who engage with the video communication platform may solely interact with the external video communications platform and bypass the organization's website. This may result in missed business opportunities, as well as the inability to collect personal information corresponding to the users who participate in video communications services with the organization.

Although video communications platforms provide some video messaging capabilities, traditional video communications platforms remain separate and distinct from an organization's website, which may create inefficiencies. For example, a visitor may need a special URL that may continuously change in order to access the video communication platform. As a result, the visitor may struggle with accessing the video communications platform due to a complicated URL. The traditional video communication platform may also lack any personalization regarding the organization and/or a particular user. Accordingly, there is a need for a video communications platform that is hosted by an external server system, but is rendered within the internal domain of an organization.

The present disclosure is directed to addressing the above-referenced challenges or other problems in the art. The background description provided herein is for the purpose of generally presenting the context of the disclosure. Unless otherwise indicated herein, the materials described in the background section are not prior art to the claims in the present application and are not admitted to be prior art, or suggestions of the prior art, by inclusion in the background section.

### SUMMARY OF THE DISCLOSURE

According to certain aspects of the disclosure, methods and systems are disclosed for an internal domain hosting a video communications portal of an external video communications server system.

In one aspect, an exemplary embodiment of a computer-implemented method for hosting a video communications portal of an external video communications server system on an internal domain, includes receiving, by the internal domain, a unique path from a user, the unique path including a unique identifier. The method may further include, in response to the receiving, initiating, by the external video communications server system, the video communications portal of the external video communications server system, the video communications portal corresponding to the unique identifier. The method may further include, in response to the initiating, displaying, by the external video communications server system, the video communications portal within the internal domain, wherein the video communications portal is hosted on the external video communications server system. The method may further include receiving, by the video communications portal, a user selection from the user to initiate a video communication with one or more visitors. The method may further include, in response to receiving the user selection, activating, by the video communications portal, the video communication between the user and the one or more visitors.

In a further aspect, an exemplary embodiment of a computer system for hosting a video communications portal of an external video communications server system on an internal domain, the computer system may include at least one memory storing instructions, and at least one processor configured to execute the instructions to perform operations. The operations may include receiving, by the internal domain, a unique path from a user, the unique path including a unique identifier. The operations may further include, in response to the receiving, initiating, by the external video communications server system, the video communications portal of the external video communications server system, the video communications portal corresponding to the unique identifier. The operations may further include, in response to the initiating, displaying, by the external video communications server system, the video communications portal within the internal domain, wherein the video communications portal is hosted on the external video communications server system. The operations may further include receiving, by the video communications portal, a user selection from the user to initiate a video communication with one or more visitors. The operations may further include, in response to receiving the user selection, activating, by the video communications portal, the video communication between the user and the one or more visitors.

In a further aspect, an exemplary embodiment of a non-transitory computer-readable medium containing instructions that, when executed by a processor, cause the processor to perform operations for hosting a video communications portal of an external video communications server system on an internal domain. The operations may include receiving a unique path from a user, the unique path including a unique identifier. The operations may further include, in response to the receiving, initiating the video communications portal of the external video communications server system, the video communications portal corresponding to the unique identifier. The operations may further include, in response to the initiating, displaying the video communications portal within the internal domain, wherein the video communications portal is hosted on the external video communications server system. The operations may further include receiving a user selection from the user to initiate a video communication with one or more visitors. The operations may further include, in response to receiving the user selection, activating the video communication between the user and the one or more visitors.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of the present specification, illustrate various exemplary embodiments and together with the description, serve to explain the principles of the disclosed embodiments.

FIG. 1 depicts an exemplary environment that may be utilized with techniques presented herein, according to one or more embodiments.

FIG. 2 depicts a flowchart of an exemplary method for hosting a video communications portal of an external video communications server system on an internal domain, according to one or more embodiments.

FIGS. 3A-B describe exemplary environments of a video communications portal, according to one or more embodiments.

FIG. 4 depicts an example of a computing device that may execute the techniques described herein, according to one or more embodiments.

### DETAILED DESCRIPTION OF EMBODIMENTS

The following embodiments describe systems and methods for hosting a video communications portal of an external video communications server system on an internal domain. As noted above, there exists a need for a video communications platform that is hosted by an external server system, but is rendered within the internal domain of an organization.

Organizations invest a significant amount of time and money into developing a brand that reflects a particular image that such organizations may wish to convey to third parties, such as clients, business partners, and the like. An organization's website is a large part of the organization's brand. An organization may convey a particular brand through the use of colors, fonts, content, and images on the organization's website. Additionally, employees at an organization may have a personal webpage that is a part of the organization's website, where the personal webpages may also reflect the organization's brand.

A visitor may interact with an organization via an electronic communications platform that may provide video conferencing, messaging, and the like. However, conventional electronic communications platforms may not incorporate an organization's brand. Accordingly, there is a need for an electronic communications platform that may incorporate an organization's brand before, during, and after electronic communications.

Additionally, a need exists for rendering electronic communications platforms on 404 pages of an organization's website domain. By doing so, the organization may efficiently incorporate the electronic communications platform of an external system, without the additional cost or time of creating a new website domain from scratch. Additionally, utilizing 404 pages may allow for a user to select a specific and unique path (e.g., a uniform resource locator (URL)) and associate the unique path with an electronic communications page. The user may then be able to invite users to access the electronic communications page via the unique path.

By rendering an external video communications platform within an organization's internal domain, the embodiments herein may provide an improvement in video communications technology by allowing users to communicate under an organization's brand. Additional improvements may include the ability to redirect users to other parts of the internal domain, upon completion of a video communications session. Further improvements may include the ability for an internal domain to gather personal information of visitors who participate in a video communications session. The personal information may be utilized for data analytics, personalized advertisement targeting, and the like. Further improvements may include a permanent URL to a particular video communications page within the organization's domain. The permanent URL may allow for more efficient access to the video communications page, as visitors are able to remember such URL. Additionally, further improvements may include the ability to avoid sharing personal information (e.g., phone number, email, and the like), by directing visitors to the permanent URL.

As will be discussed in more detail below, in various embodiments, systems and methods are described for hosting a video communications portal of an external video communications server system on an internal domain to a user. By receiving the unique path including a unique identifier, the systems and methods may be able to initiate, by the external video communications server system, the video communications portal of the external video communications server system, the video communications portal corresponding to the unique identifier. The systems and methods may then display, by the external video communications server system, the video communications portal within the internal domain, wherein the video communications portal is hosted on the external video communications server system. The systems and methods may then receive, by the video communications portal, a user selection from the user to initiate a video communication with one or more visitors. The systems and methods may then activate, by the video communications portal, the video communication between the user and the one or more visitors.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the general description and the detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It should be appreciated that in the below description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

### Exemplary Environment

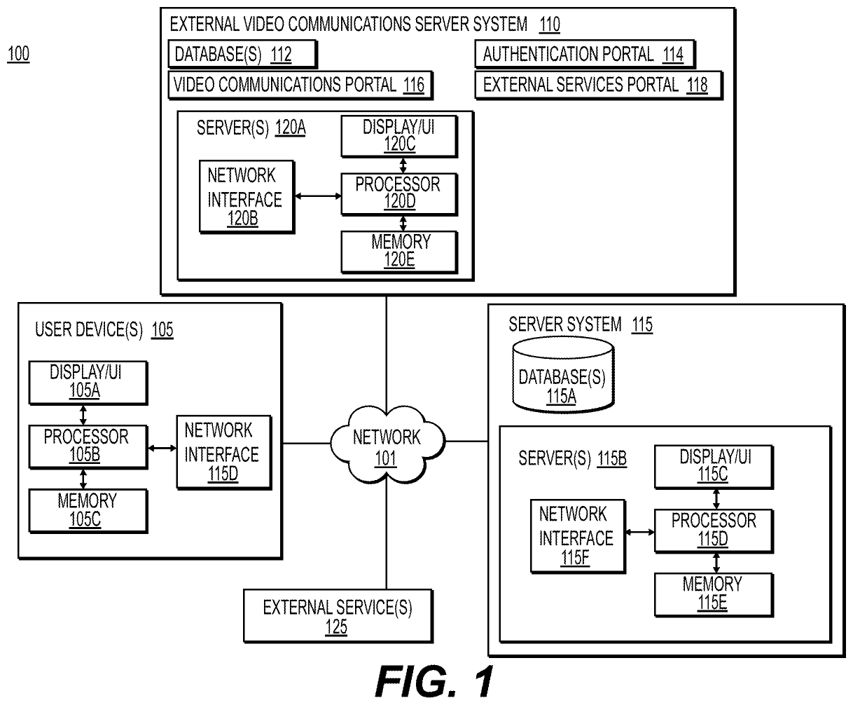

FIG. 1 depicts an exemplary environment 100 that may be utilized with techniques presented herein. One or more user device(s) 105, one or more external video communications server system(s) 110, one or more server system(s) 115, and one or more external service(s) 125 may communicate across a network 101. As will be discussed in further detail below, external video communications server system 110 may communicate with one or more of the other components of the environment 100 across network 101. The one or more user device(s) 105 may be associated with one or more users.

In some embodiments, the components of the environment 100 are associated with a common entity, e.g., a business, an organization, or the like. In some embodiments, one or more of the components of the environment are associated with a different entity than another. The systems and devices of the environment 100 may communicate in any arrangement.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” or “webpage” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The user device(s) 105 may be configured to enable the user to access and/or interact with other systems in the environment 100. In some embodiments, the user may correspond to an owner of a particular webpage. An owner of a particular webpage may be associated with such webpage. For example, the webpage may include personal information corresponding to the owner. Additionally, in some embodiments, the user may correspond to one or more visitors of a particular webpage. The one or more visitors may navigate to a particular webpage to interact with the owner of the webpage. The one or more visitors may not be associated with the particular webpage.

In some embodiments, the user device 105 may be a computer system such as, for example, a desktop computer, a mobile device, a tablet, and the like. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

The external video communications server system 110 may include an electronic data system, e.g., a computer-readable memory such as a hard drive, flash drive, disk, and the like. In some embodiments, the external video communications server system 110 includes and/or interacts with an application programming interface for exchanging data to other systems, e.g., one or more of the other components of the environment.

The external video communications server system 110 may include a database 112 and at least one server 120A. The external video communications server system 110 may be a computer, system of computers (e.g., rack server(s)), and/or or a cloud service computer system. The external video communications server system 110 may store or have access to database 112 (e.g., hosted on a third party server or in memory 120E). Database 112 may store video messages, data corresponding to one or more video communications session, one or more user profiles, and the like. The external video communications server system 110 may include an authentication portal 114, a video communications portal 116, and/or an external services portal 118. The external video communications server system 110 may include a display/UI 120C, a processor 120D, a memory 120E, and/or a network interface 120B. The display/UI 120C may be a touch screen or a display with other input systems (e.g., mouse, keyboard, etc.) for an operator of the server 120A to control the functions of the server 120A. The external video communications server system 110 may execute, by the processor 120D, an operating system (O/S) and at least one instance of a servlet program (each stored in memory 120E).

External video communications server system 110 may be, for example, one or more third party and/or auxiliary systems that integrate and/or communicate with the server system 115 in performing various video communications tasks. External video communications server system 110 may be in communication with other device(s) or system(s) in the environment 100 over the one or more networks 101. For example, external video communications server system 110 may communicate with the server system 115 via API (application programming interface) access over the one or more networks 101, and also communicate with the user device(s) 105 via web browser access over the one or more networks 101. Additionally, external video communications server system 110 may be in communication with external service(s) 125 via API access over one or more networks (e.g., network 101). External service(s) 125 may include one or more social media applications (e.g., Instagram, Twitter, and the like), one or more business applications (e.g., LinkedIn and the like), and/or one or more additional applications not hosted on the external video communications server system 110.

User device 105 may communicate with external video communications server system 110 through one or more applications for video communications comprising one or more web-based portals of user interfaces for video communications. The web-based portals may include authentication portal 114, video communications portal 116, and/or external services portal 118. Each portal may generate or present one or more graphical user interfaces on a display of user device 105. Additionally, user interactions with authentication portal 114, video communications portal 116, and/or external services portal 118 may trigger background tasks of the external video communications server system 110.

Authentication portal 114 may include one or more user interfaces for authenticating a user. The authentication portal 114 may present one or more user interfaces requesting that the user submit authentication credentials. Such authentication credentials may include two-factor authentication, a one-time password authentication (OTP), a username and password, social media account credentials, a mobile device number (e.g., corresponding to user device 105), and/or single sign on credentials. If the user provides incorrect authentication credentials, the authentication portal 114 may display a user interface indicating that incorrect authentication credentials were provided by the user and/or indicating that the user should submit new user credentials.

Video communications portal 116 may include one or more user interfaces for initiating, facilitating, and/or completing video communications between a one or more users. The video communications portal 116 may also present one or more customized user interfaces, where the customized user interfaces may reflect a particular user's choices and/or a particular user's personal information (e.g., the user's name). The video communications portal 116 may display different user interfaces to a visitor depending on the availability of the owner of the webpage. For example, if an owner is available, the video communications portal 116 may display one or more user interfaces allowing one or more visitors to initiate a video communications session with the owner. Additionally, for example, if an owner is unavailable, the video communications portal 116 may display one or more user interfaces allowing one or more visitors to send a video communication (e.g., a video message) to the owner.

External services portal 118 may include one or more user interfaces for displaying one or more links to external service(s) 125. For example, the one or more links may correspond to an external service page, such as one or more social media networks corresponding to the user (e.g., the user's Instagram page), one or more business networks corresponding to the user (e.g., the user's LinkedIn page), and the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system 115 may store or have access to database 115A (e.g., hosted on a third party server or in memory 115E). The server system 115 may include a display/UI 115C, a processor 115D, a memory 115E, and/or a network interface 115F. The display/UI 115C may be a touch screen or a display with other input systems (e.g., mouse, keyboard, etc.) for an operator of the server 1156 to control the functions of the server 1156. The server system 115 may execute, by the processor 115D, an operating system (O/S) and at least one instance of a servlet program (each stored in memory 115E).

User device 105 may access server system 115, where the server system 115 may redirect user device 105 to external video communications server system 110, where a user may engage in synchronous and/or asynchronous video communications with other users.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

In the previous and following methods, various acts may be described as performed or executed by a component from FIG. 1, such as the server system 115, the user device 105, the external video communications server system 110, or components thereof. However, it should be understood that in various embodiments, various components of the environment 100 discussed above may execute instructions or perform acts including the acts discussed above. An act performed by a device may be considered to be performed by a processor, actuator, or the like associated with that device. Further, it should be understood that in various embodiments, various steps may be added, omitted, and/or rearranged in any suitable manner.

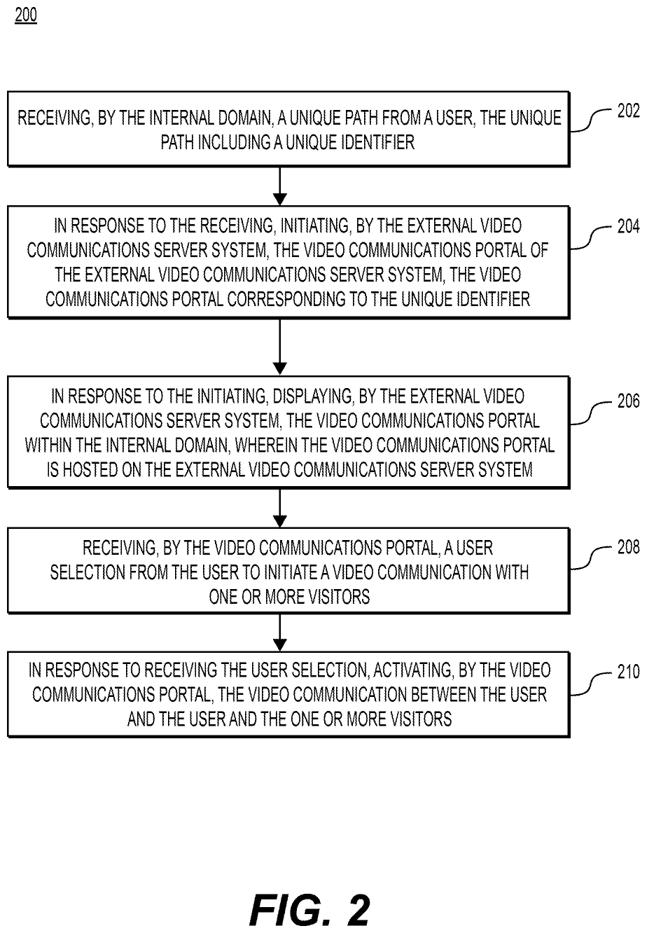

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Method for Hosting a Video Communications Portal

FIG. 2 illustrates an exemplary process 200 for hosting a video communications portal of an external video communications server system 110 on an internal domain, according to one or more embodiments.

The method may include receiving, by the internal domain, a unique path from a user, the unique path including a unique identifier (Step 202). A server system (e.g., server system 115) may host the internal domain. The user may enter the unique path, such as a URL, into a web browser, where the unique path may identify a unique location corresponding to the internal domain.

The internal domain may correspond to a particular website “brand” (e.g., a company website, an organization website, or the like). Additionally, for example, the internal domain may have a particular style, such as a particular logo, particular colors, a particular font, particular content, particular images, and the like. In some embodiments, the internal domain may include one or more webpages that correspond to one or more users that belong to the internal domain. For example, the internal domain may correspond to a particular company, where the internal domain includes one or more webpages of one or more employees of the particular company. Alternatively, in some embodiments, the internal domain may correspond to an external video communications server system 110 (e.g., external video communications server system 110), where the one or more users selected a page hosted by the external video communications server system 110. The internal domain may be hosted on a server system (e.g., server system 115) that may be separate from the external video communications server system 110 (e.g., external video communications server system 110).

The unique path may correspond to a particular URL. Additionally, the unique path may include a unique identifier. In some embodiments, the particular URL may include characters indicating that the URL corresponds to the internal domain and the URL may include the unique identifier (e.g., www.CompanyA.com/1234, where the internal domain may be “Company A” and the unique path may be “1234”). In some embodiments, the unique path may include a hash (#) that may act as a direct trigger to initiate the internal domain and/or external video communications server system 110. Additionally, the hash may be a part of and/or identify the unique identifier. For example, the unique path may be “www.CompanyA.com/#1234,” where the internal domain may be “Company A” and the “#1234” may be the unique identifier that triggers the internal domain and/or external video communications server system 110. In some embodiments, the hash may directly follow a forward slash (e.g., “/#”).

Additionally, or alternatively, the unique path may correspond to a 404 page. A 404 page may indicate an error, where a URL (e.g., a mistyped URL) corresponds to a webpage that was not found on a web server (e.g., server system 115). A user may make a Hypertext Transfer Protocol (HTTP) request for a webpage that does not exist. In such a scenario, a 404 page may be displayed. The 404 page may act as a placeholder webpage to notify the user of the error. For example, the unique path “www.CompanyA.com/1234,” may correspond to the internal domain of Company A, but the unique identifier “1234” may correspond to a webpage that does not exist on the internal domain of Company A. As a result, in such an example, the unique path “www.CompanyA.com/1234” may correspond to a 404 page.

The method may further include, in response to the receiving, initiating, by the external video communications server system 110, the video communications portal of the external video communications server system 110, the video communications portal corresponding to the unique identifier (Step 204). The external video communications server system 110 (e.g., external video communications server system 110) may include a video communications portal (e.g., video communications portal 116) for initiating, facilitating, and/or completing video communications between a one or more users. In some embodiments, the internal domain may receive the unique path, analyze the unique identifier, and forward the unique path and/or the unique identifier to the external video communications server system 110. Upon receiving the unique path and/or the unique identifier, the external video communications server system 110 may analyze the unique identifier to determine a video communications portal that corresponds to the unique identifier.

In some embodiments, the server system of the internal domain (e.g., server system 115) may initiate the external video communications server system 110. For example, a user with administrator credentials to the server system and/or internal domain may provide an external video communications server system 110 connection to the internal domain and/or server system. Such a connection may be in the form of a piece of code (e.g., a line of JavaScript code). Additionally, the connection may not require a download of one or more software modules. Upon implementation of the external video communications server system 110 connection, the external video communications server system 110 may create one or more user profiles that include one or more unique paths.

The unique path may correspond to a particular user interface of the video communications portal. In some embodiments, the external video communications server system 110 may have created the unique path. For example, upon creating the unique path, where the unique path may correspond to a 404 page, the external video communications server system 110 may provide the unique path to the internal domain. In some embodiments, the server system of the internal domain (e.g., server system 115), may store the unique path and a corresponding indicator that may specify that the unique path corresponds to the external video communications server system 110.

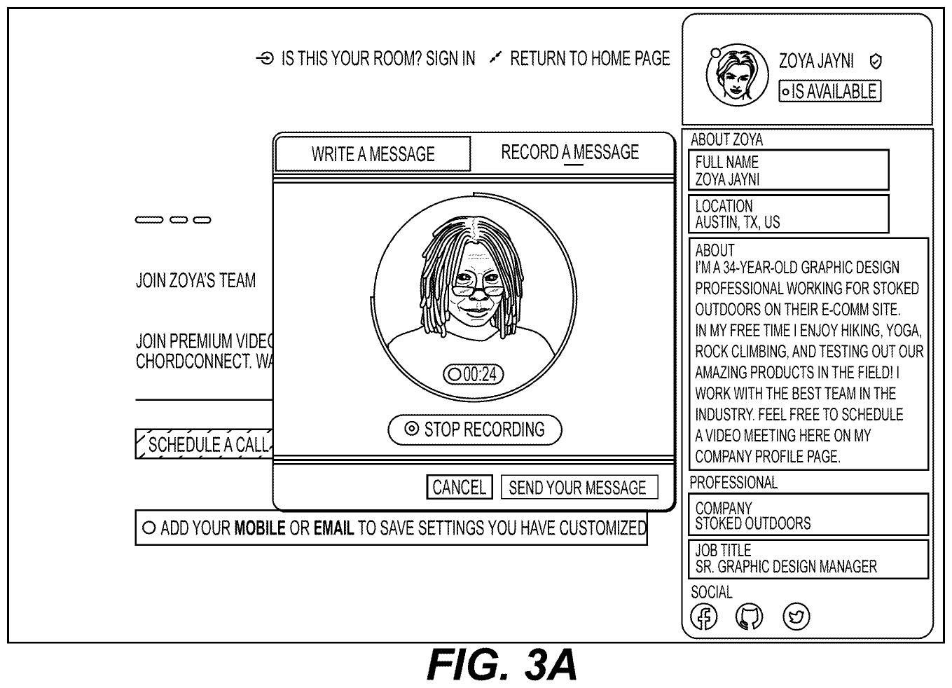

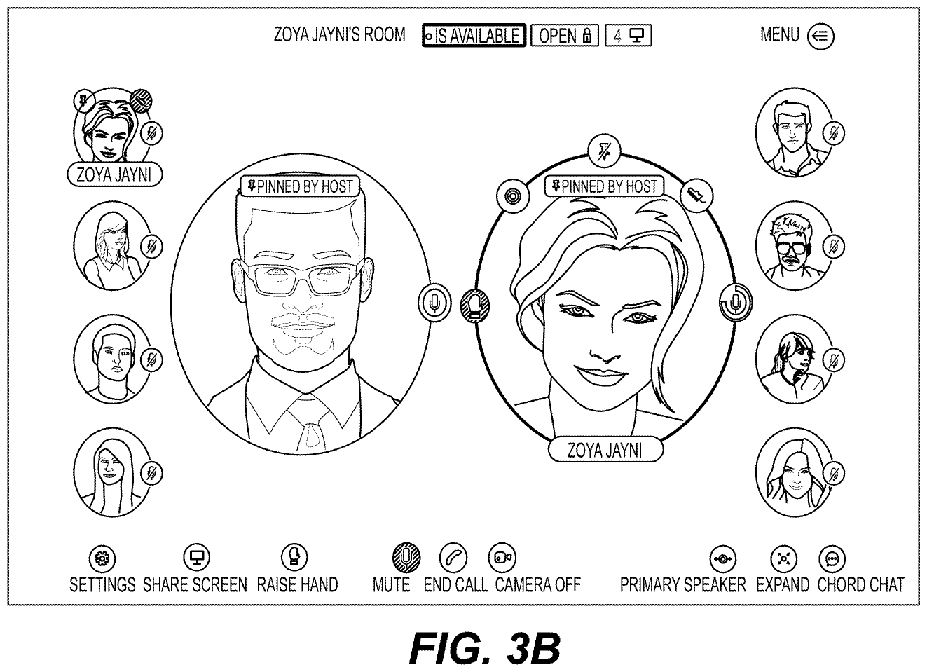

The external video communications server system 110 may store (e.g., in database 112) one or more user interfaces of the video communications portal, where each of the one or more user interfaces may correspond to a particular unique identifier. In some embodiments, the external video communications server system 110 may store a user profile for each owner of the one or more user interfaces. For example, the external communications server may store the one or more user profiles in one or more database records (e.g., in database 112). In such an embodiment, the stored user profile may include one or more user interfaces that may contain personal information of the owner (e.g., a user name, a user picture, and the like). Additionally, the unique identifier may correspond to the stored user profile. Upon the external video communications server system 110 receiving the unique identifier, the external video communications server system 110 may initiate a video communications portal that includes one or more user interfaces corresponding to the unique identifier. Examples of such user interfaces may be further illustrated in FIGS. 3A and 3B. Each of the user profiles may have associated authentication credentials, where the owner may need to provide the correct credentials in order to access and/or edit the video communications portal.

In some embodiments, the external video communications server system 110 may also include an external services portal (e.g., external services portal 118) that may include one or more links to one or more social media networks (e.g., Instagram). Additionally, for example the external services portal may include one or more links to one or more business networks (e.g., LinkedIn) corresponding to the user.

In some embodiments, the method may further include, in response to the initiating, displaying, by the external video communications server system 110, an authentication portal of the external video communications server system 110. The authentication portal (e.g., authentication portal 114) may include one or more user interfaces for authenticating a user. The external video communications server system 110 may store authentication credentials corresponding to the user (e.g., an owner) of a particular video communications portal (e.g., video communications portal 116). In some embodiments, the authentication portal may present one or more user interfaces requesting that the user submit authentication credentials. Additionally, for example, when the unique path corresponds to a 404 page, the external video communications server system 110 may “take over” the 404 page and render the video communications portal over the 404 page.

The method may also include authenticating, by the authentication portal, the user in response to receiving authentication credentials from the user, the authentication credentials including at least one of: a mobile device number or a social media account credentials. Example authentication credentials may include at least one of: two-factor authentication, a username and password, social media account credentials, a mobile device number (e.g., corresponding to user device 105) and/or single sign on credentials. Additionally, in some embodiments, the external video communications server system 110 may store authentication credentials corresponding to an owner of the particular video communications portal, as well as authentication credentials corresponding to one or more visitors of the particular video communications portal. For example, the owner of a particular video communications portal may have authentication credentials in the form of a username and password, where the one or more visitors of such video communications portal may have authentication credentials in the form of a personal identification number (PIN).

The method may further include, in response to the initiating, displaying, by the external video communications server system 110 (e.g., external video communications server system 110), the video communications portal (e.g., video communications portal 116) within the internal domain (e.g., of server system 115), wherein the video communications portal is hosted on the external video communications server system 110 (Step 206). The displayed video communications portal may include one or more user interfaces corresponding to the unique identifier. Additionally, the internal domain may display the video communications portal, where the one or more user interfaces of the video communications portal have the same customized appearance (e.g., color, font, and the like) of the internal domain. Even though the video communications portal may be displayed within the internal domain, the video communications portal may be hosted on the external video communications server 110, whereas the internal domain may be hosted on a different server system.

The method may further include receiving, by the video communications portal, a user selection from the user to initiate a video communication with one or more visitors (Step 208). For example, a user may select a button on the user display, which displays the video communications portal, to begin a video communication session with one or more other users.

The method may further include, in response to receiving the user selection, activating, by the video communications portal, the video communication between the user and the one or more visitors (Step 210). Upon receiving the user selection to begin a video communication session, the video communications portal may activate the video communication session between the one or more users. Additionally, the video communications portal may display a notification indicating the beginning of the video communications session.

In some embodiments, the method may further include receiving, by the video communications portal, an additional user selection indicating an end of the video communication and a redirect request, the redirect request including at least one redirect path within the internal domain. At least one user may select a button in the video communications portal to end the video communications session. Upon receiving the user selection, the video communications portal may terminate the video communications session. Additionally, the video communications portal may display a notification indicating the termination of the video communications session. In some embodiments, the video communications portal may receive a redirect request from one of the users. The redirect request may include a path (e.g., a URL) indicating a location on the internal domain. In some embodiments, the location may not be on the internal domain. Additionally, the redirect request may include one or more indicators corresponding to one or more users, where the user devices corresponding to the one or more indicators should be redirected to the redirect path upon termination of the video communications session.

The method may also include redirecting, by the video communications portal, the one or more visitors to the at least one redirect path within the internal domain. For example, upon ending the video communications session, the video communications portal may automatically redirect the one or more visitors to a user interface that corresponds to the at least one redirect path. In some embodiments, a subset of the one or more visitors may be redirected to the at least one redirect path, where the subset of the one or more visitors may be specified by the user (e.g., the page owner) in the redirect request. The at least one redirect path may correspond to at least one webpage within the internal domain. In some embodiments, the at least one redirect path may correspond to at least one webpage that is not within the internal domain. Additionally, in some embodiments, the redirect request may include at least one path to a virtual shopping cart within the internal domain. For example, the redirect request may correspond to an online store, where the one or more visitors may purchase products and/or services.

In some embodiments, the method may further include storing, by the internal domain, personal information corresponding to the one or more visitors. When the one or more visitors visit the video communications portal of a page owner, the video communications portal may prompt the one or more visitors to provide personal information (e.g., a name, a user name, a birthday, a location, an email, a phone number, a home address, an ethnicity, and the like). The external video communications server system 110 may receive the personal information from the video communications portal. The external video communications server may store such personal information. Additionally, or alternatively, the external video communications server may send such personal information to the internal domain and/or the server system of the internal domain (e.g., server system 115). The internal domain and/or the server system of the internal domain may store such personal information corresponding to the one or more users (e.g., in database 115A).

The method may also include utilizing, by the internal domain, the personal information for data analytics and personalized advertisement targeting. The internal domain and/or the server system of the internal domain (e.g., server system 115) may utilize the personal information of the one or more visitors to determine one or more patterns, where such information may be used for marketing purposes. Additionally, the personal information of the one or more visitors may be utilized for personalized advertisement targeting, where the personal information may indicate the type of electronic advertisements that should either be used and/or avoided on the internal domain.

In some embodiments, the method may further include receiving, by the external video communications server system 110, an electronic video message from the one or more visitors. For example, the method may allow one or more visitors to make a selection in the video communications portal to record an electronic video message for the owner. Once the one or more visitors record the electronic video message, the electronic video communications server system may receive and store the electronic video message (e.g., in database 112).

The method may also include determining, by the external video communications server system 110, an availability status corresponding to the user. For example, the user (e.g., an owner of the particular video communications portal) may have an “available” status that may indicate that the user is available for a video communications session. Additionally, the user may have an “unavailable” status that may indicate that the user is not available for a video communications session. For example, the user may have an “unavailable” status when the user is not near an electronic device or when the user may already be in a video communications session. In some embodiments, the user may be able to select whether the user has an “available” or “unavailable” status. Additionally, the availability status may be displayed on the user's particular page.

The method may also include, in response to determining that the availability status includes an unavailable status, sending, by the external video communications server system 110, an electronic message to a user device, where the electronic message includes a link to the electronic video message. If the user (e.g., the owner of the particular video communications portal) has an “unavailable” status, the external video communications server system 110 may send an electronic message to a user device (e.g., user device 105). The electronic message may be sent to the user device in the form of an email, an SMS text message, an iMessage, and the like. Additionally, the electronic message may include the electronic video message. Additionally, or alternatively, the electronic message may include a link to the electronic video message. When the user selects the link in the electronic video message, the electronic video communications server system may retrieve the electronic video message from storage (e.g., database 112), and the electronic video communications server system may play the electronic video message on the user device.

Although FIG. 2 shows example blocks of exemplary method 200, in some implementations, the exemplary method 200 may include additional blocks, fewer blocks, different blocks, or differently arranged blocks than those depicted in FIG. 2. Additionally, or alternatively, two or more of the blocks of the exemplary method 200 may be performed in parallel.

### Exemplary Video Communications Platform

FIGS. 3A-B describe exemplary environments of a platform for hosting a video communications portal of an external video communications server system 110 on an internal domain, according to one or more embodiments.

FIG. 3A describes an exemplary environment of a video communications portal where a visitor may send the owner an electronic video message. The video communications portal may include an availability status regarding the availability of the owner (e.g., “is Available”). The video communications portal may also include the owner's personal information (e.g., full name, location, company, job title, and the like). The video communications portal may also include an “about” section that may include additional personal information regarding the owner. The video communications portal may also include one or more links to one or more social media and/or business pages of the owner.

Visitors of the owner's page may have an option to schedule a call with the owner, instantly start a video communications session with the owner, write a message to the owner, and/or record an electronic video message for the owner. When the visitor selects the option to schedule a call with the owner, the video communications portal may provide the visitor with a calendar that indicates the owner's availability. The visitor may be able to select an available time and proceed to schedule a call with the owner. When the visitor selects the option to instantly start a video communications session, the video communications portal may facilitate the initiation of the video communications session between the visitor and the owner. When the visitor selects the option to write a message to the owner, the video communications portal may send a completed message via text message and/or email to the owner's device. When the visitor selects the option to record a message for the owner, the video communications portal may receive an electronic video message from the visitor. The external video communications server system 110 may then send the owner a link to view the electronic video message. The link may be sent via text message and/or email to the user device.

FIG. 3B describes an exemplary environment of the video communications portal. The video communications portal may allow for users to communicate in a synchronous and/or asynchronous manner, where users may speak with each other, share files, screen share, stream media, and the like. Additionally, the video communications portal may allow users to send instant messages in the video communications portal, as well as send messages to different user devices (e.g., a text message).

The video communications portal may have one or more user interfaces. Example user interfaces may include a broadcast user interface, a host user interface, a landscape user interface, and the like. The video communications portal may include images corresponding to one or more of the users. The images may include still photos or a live video of the one or more users. Additionally, the images may be cropped in a square shape, a circle shape, an oval shape, and the like. The owner may preemptively provide speaking privileges to particular visitors. For example, the owner may press a mute button for any of the users that do not have speaking privileges. Additionally, the owner may pin one or more images corresponding to one or more visitors, where the pinned images may be larger than the rest of the images. Each user (both the owner and the one or more visitors) may have the option to mute themselves, turn off the camera, raise a virtual hand, and/or end the video communications. If the owner ends the video communications session, the entire video communications session may be terminated. If one of the visitors ends the video communications session, the visitor may leave the video communications session, but the session may continue on without the visitor. The owner may have the option to determine whether the video communications session is “open” or “closed”. Additionally, there may be “stand alone” rooms that do not belong to a particular user. Instead, anyone may join such a room for a video communications session. For example, if the video communications session is “open,” then any visitor may be able to join. Additionally, for example, if the video communications session is “closed,” then only the visitors with the proper credentials (e.g., a user name and password, a PIN, and the like) may be able to join the video communications session.

The external video communications server system 110 may also include a community wall that may also be located within the internal domain. The community wall may act as a centralized hub for all of the owners of a video communications portal within the internal domain. The community wall may also allow one or more users to post messages, record videos, and the like, within the internal domain. The community wall may be open to all users or it may require users to provide authentication credentials in order to access the community wall.

### Exemplary Device

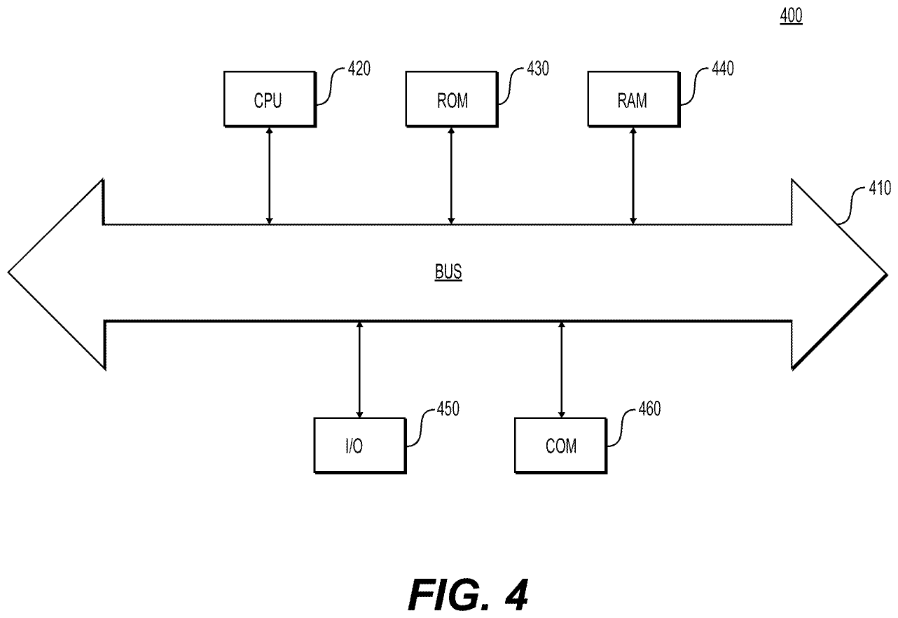

FIG. 4 is a simplified functional block diagram of a computer 400 that may be configured as a device for executing the environments and/or the methods of FIGS. 2-3, according to exemplary embodiments of the present disclosure. For example, device 400 may be a part of user device 105, server system 115, external video communications server system 11, network 101, and/or external service 125. Additionally, for example, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for hosting a video communications portal of an external video communications server system on an internal domain, the method comprising:
receiving, by the internal domain, a unique path from a user, the unique path including a unique identifier;
in response to the receiving, initiating, by the external video communications server system, the video communications portal of the external video communications server system, the video communications portal corresponding to the unique identifier;
in response to the initiating, displaying, by the external video communications server system, the video communications portal within the internal domain, wherein the video communications portal is hosted on the external video communications server system;
receiving, by the video communications portal, a user selection from the user to initiate a video communication with one or more visitors; and
in response to receiving the user selection, activating, by the video communications portal, the video communication between the user and the one or more visitors.

2. The computer-implemented method of claim 1, wherein the unique path corresponds to a 404 page.

3. The computer-implemented method of claim 1, wherein the unique path includes a hash.

4. The computer-implemented method of claim 1, wherein the unique path identifies a unique location within the internal domain.

5. The computer-implemented method of claim 1, wherein the internal domain is hosted on a server system separate from the external video communications server system.

6. The computer-implemented method of claim 1, wherein in the external video communications server system created the unique path.

7. The computer-implemented method of claim 1, the method further comprising:
receiving, by the video communications portal, an additional user selection indicating an end of the video communication and a redirect request, the redirect request including at least one redirect path within the internal domain; and
redirecting, by the video communications portal, the one or more visitors to the at least one redirect path within the internal domain.

8. The computer-implemented method of claim 7, wherein the redirect request includes at least one shopping cart path to a virtual shopping cart within the internal domain.

9. The computer-implemented method of claim 1, the method further comprising:
in response to the initiating, displaying, by the external video communications server system, an authentication portal of the external video communications server system; and
authenticating, by the authentication portal, the user in response to receiving authentication credentials from the user, the authentication credentials including at least one of: a mobile device number or a social media account credentials.

10. The computer-implemented method of claim 1, the method further comprising:
storing, by the internal domain, personal information corresponding to the one or more visitors; and
utilizing, by the internal domain, the personal information for data analytics and personalized advertisement targeting.

11. The computer-implemented method of claim 1, the method further comprising:
receiving, by the external video communications server system, an electronic video message from the one or more visitors;
determining, by the external video communications server system, an availability status corresponding to the user; and
in response to determining that the availability status includes an unavailable status, sending, by the external video communications server system, an electronic message to a user device, where the electronic message includes a link to the electronic video message.

12. The computer-implemented method of claim 1, the external video communications server system including an external services portal that includes one or more links to one or more social media networks.

13. A computer system for hosting a video communications portal of an external video communications server system on an internal domain, the computer system comprising:
at least one memory storing instructions; and
at least one processor configured to execute the instructions to perform operations comprising:
receiving, by the internal domain, a unique path from a user, the unique path including a unique identifier;
in response to the receiving, initiating, by the external video communications server system, the video communications portal of the external video communications server system, the video communications portal corresponding to the unique identifier;
in response to the initiating, displaying, by the external video communications server system, the video communications portal within the internal domain, wherein the video communications portal is hosted on the external video communications server system;
receiving, by the video communications portal, a user selection from the user to initiate a video communication with one or more visitors; and
in response to receiving the user selection, activating, by the video communications portal, the video communication between the user and the one or more visitors.

14. The computer system of claim 13, wherein the unique path corresponds to a 404 page.

15. The computer system of claim 13, wherein the unique path includes a hash.

16. The computer system of claim 13, wherein the unique path identifies a unique location within the internal domain.

17. The computer system of claim 13, wherein the internal domain is hosted on a server system separate from the external video communications server system.

18. A non-transitory computer-readable medium containing instructions that, when executed by a processor, cause the processor to perform operations for hosting a video communications portal of an external video communications server system on an internal domain, the operations comprising:
receiving a unique path from a user, the unique path including a unique identifier;
in response to the receiving, initiating the video communications portal of the external video communications server system, the video communications portal corresponding to the unique identifier;
in response to the initiating, displaying the video communications portal within the internal domain, wherein the video communications portal is hosted on the external video communications server system;
receiving a user selection from the user to initiate a video communication with one or more visitors; and
in response to receiving the user selection, activating the video communication between the user and the one or more visitors.

19. The non-transitory computer-readable medium of claim 18, wherein the unique path corresponds to a 404 page.

20. The non-transitory computer-readable medium of claim 18, wherein the internal domain is hosted on a server system separate from the external video communications server system.
